(19) United States
(12) Patent Application Publication
(10) Pub. No.: US 2004/0057817 A1
(43) Pub. Date: Mar. 25, 2004

(54) Switchable damping mechanism for use in a stage apparatus

(76) Inventor: Andrew J. Hazelton, San Carlos, CA (US)

Correspondence Address: RITTER, LANG & KAPLAN, 12930 SARATOGA AE. SUITE D1, SARATOGA, CA, 95070, US

(21) Appl. No.: 10/253,947

(22) Filed: Sep. 24, 2002

(51) Int. Cl. B65G 1/00; B65G 65/00

(52) U.S. Cl. 414/271

(57) ABSTRACT

Methods and apparatus for damping vibrations within a stage device using controllable dampers are disclosed. According to one aspect of the present invention, a method for adjusting an amount of resistance associated with a stage device which has a table, a first surface, and a coupler positioned substantially between the table and the first surface includes accelerating the table and applying a resistance between the table and the first surface when the table is accelerating. Applying the resistance includes providing a first adjustment to the coupler. The method also includes substantially removing the resistance from between the table and the first surface when the table is not accelerating, wherein the resistance is substantially removed by providing a second adjustment to the coupler. In one embodiment, the stage device further includes a first damper that is arranged to substantially damp an elastic body vibration of the wafer table.

### BACKGROUND OF THE INVENTION

1. Field of Invention

The present invention relates generally to semiconductor processing equipment. More particularly, the present invention relates to a damping mechanism that reduces vibrations associated with a wafer table when the wafer table is accelerating, but does not adversely affect the wafer table during a wafer exposure process.

2. Description of the Related Art

For precision instruments such as photolithography machines which are used in semiconductor processing, factors which affect the performance, e.g., accuracy, of the precision instrument generally must be dealt with and, insofar as possible, eliminated. When the performance of a precision instrument is adversely affected, as for example by vibrations, products formed using the precision instrument may be improperly formed and, hence, function improperly. For instance, a photolithography machine which is subjected to vibrations may cause an image projected by the photolithography machine to move, and, as a result, be aligned incorrectly on a projection surface such as a semiconductor wafer surface. Further, vibrations may cause control problems during an acceleration portion of a scanning process or a scan.

Scanning stages such as wafer scanning stages and reticle scanning stages are often used in semiconductor fabrication processes, and may be included in various photolithography and exposure apparatuses. Wafer scanning stages are generally used to position a semiconductor wafer such that portions of the wafer may be exposed as appropriate for masking or etching. Reticle scanning stages are generally used to accurately position a reticle or reticles for exposure over the semiconductor wafer. Patterns are generally resident on a reticle, which effectively serves as a mask or a negative for a wafer. When a reticle is positioned over a wafer as desired, a beam of light or a relatively broad beam of electrons may be collimated through a reduction lens, and provided to the reticle on which a thin metal pattern is placed. Portions of a light beam, for example, may be absorbed by the reticle while other portions pass through the reticle and are focused onto the wafer.

Within a photolithography apparatus, vibrations may be particularly problematic, especially when the vibrations are excited to uncontrollable levels during the acceleration and the deceleration of components of the apparatus, such as a wafer table. While such vibrations often cause accuracy issues during an acceleration or deceleration portion of an overall wafer scanning process, the same vibrations often do not significantly affect the accuracy of a constant velocity, or exposure portion, of a scan. In other words, although vibrations may cause significant stage control problems during an acceleration or deceleration portion of an overall scanning process, vibrations generally do not significantly affect the ability to control the stage during an exposure portion of the scanning process. However, the transient acceleration or deceleration effects which may remain from the acceleration portion of a scanning process may cause accuracy issues to arise during the exposure portion of the scanning process.

Transient effects which result from acceleration or deceleration of a wafer table may result in measurement inconsistencies. For example, inertia may be exerted on an interferometer mirror, which is used to enable an interferometer to effectively determine a location of the wafer table, when a wafer table accelerates. As will be appreciated by those skilled in the art, a conventional interferometer such as a laser interferometer generally uses mirrors to facilitate a determination of the position of the wafer table. The inertia exerted on an interferometer mirror may cause the interferometer mirror to vibrate and, hence, deflect. Deflection of the interferometer mirror may cause the interferometer mirror to bend significantly, e.g., the interferometer mirror may bend by up to approximately 600 nanometers (nm). If the interferometer mirror bends when the wafer table accelerates or decelerates, once the wafer table has ceased to accelerate or to decelerate, transient effects may be such that the interferometer mirror has not returned to an unbent state before a wafer exposure portion of an overall scan begins. When the interferometer mirror is bent or flexed during wafer exposure, measurement inconsistencies may occur due to the interferometer mirror effectively being moved from an anticipated position while a wafer situated on the wafer table has not moved. Inconsistent or inaccurate position measurements may result in an inaccurate wafer exposure.

Since vibrations during an acceleration or deceleration portion of a wafer scan may compromise the accuracy of the scan, e.g., by causing an interferometer mirror to bend, mechanisms are often incorporated into a photolithography apparatus or, more generally, a precision instrument which includes a wafer table or a stage. The mechanisms are generally arranged to effectively reduce the effect of the vibrations. Such mechanisms typically include passive dampers which apply damping within the precision instrument. Typically, as will be understood by those skilled in the art, dampers often include hysteretic materials which dissipate the energy associated with vibrations. Although hysteretic materials are effective in absorbing vibrational energy and, hence, reducing the effect of vibrations, hysteric materials often introduce hysteresis with respect to the precision instrument. By way of example, hysteretic materials may introduce hysteretic effects which result in the distortion of a wafer table. When the wafer table is distorted during the exposure portion of a scan, the accuracy with which a wafer may be exposed may be adversely affected and, hence, a semiconductor formed using the wafer may not be reliable. That is, more generally, the integrity of an exposure portion of a scan may be affected.

Therefore, what is desired is a method and an apparatus which damps vibrations during an acceleration or deceleration portion of a scan substantially without adversely affecting a wafer exposure portion of the scan. That is, what is needed is a system which damps vibrations when a wafer table is accelerating or decelerating, but does not cause a distortion of the wafer table during an exposure process.

### SUMMARY OF THE INVENTION

The present invention relates to damping vibrations within a stage device using controllable dampers. According to one aspect of the present invention, a method for adjusting an amount of resistance associated with a stage device which has a table, a first surface, and a coupler positioned substantially between the table and the first surface includes accelerating the table and applying a resistance between the table and the first surface when the table is accelerating. Applying the resistance includes providing a first adjustment to the coupler. The method also includes substantially removing the resistance from between the table and the first surface when the table is not accelerating, wherein the resistance is substantially removed by providing a second adjustment to the coupler. In one embodiment, the stage device further includes a first damper that is arranged to substantially damp an elastic body vibration of the wafer table. In such an embodiment, the method may also include applying a damping to the wafer table to substantially counteract the elastic body vibration of the wafer table, wherein applying the damping includes substantially adjusting the first damper.

In another embodiment, the coupler is a controllable damper arrangement, and applying the resistance between the table and the first surface includes increasing a signal provided to the controllable damper arrangement. In such an embodiment, substantially removing the resistance from between the table and the first surface includes decreasing the signal provided to the controllable damper arrangement.

Damping elastic body vibrations on a wafer table of a stage device, as well as vibrations between the wafer table and a long mirror, or a mirror associated with an interferometer, during an acceleration portion of a scan reduces the effect of vibrations on the stage device. Using a controllable damper or dashpot to provide damping, e.g., during an acceleration portion of a scan, enables the amount of damping to be varied as needed. In addition, the controllable damper enables no damping to be applied when appropriate, e.g., during an exposure or constant velocity portion of a scan. As a result, distortion of the of a wafer table may be reduced during exposure, along with the effect of vibrations during acceleration.

According to another aspect of the present invention, a method for performing a scan using a stage device which has a table and a damping device includes initiating a scan using the table. Initiating the scan using the table may excite at least one elastic body vibration mode associated with the table. The elastic body vibration mode may cause a deflection of at least a section of the table. The method also includes adjusting a parameter associated with the damping device to substantially counteract the elastic body vibration mode to substantially reduce the deflection. In one embodiment, the damping device is a magneto-rheological damper arrangement, and the method further includes determining when the elastic body vibration mode is not excited, and adjusting the magneto-rheological damper arrangement to provide substantially no damping when it is determined that the elastic body vibration mode is not excited.

In accordance with another aspect of the present invention, a stage apparatus includes a first stage, a mirror, at least one actuator, and a first arrangement. The actuator enables the first stage to scan, and may excite at least one vibrational mode associated with the stage apparatus. The first arrangement is positioned between the first stage and the mirror, and receives a variable signal that controls an amount of resistance associated with the first arrangement. A first amount of resistance is arranged to cause the vibrational mode to be substantially damped. In one embodiment, the first stage is arranged to have an associated elastic body vibration mode, and the stage apparatus further includes a second arrangement that is positioned on the first stage. Such a second arrangement receives a controllable signal that controls an amount of resistance associated with the second arrangement. A second amount of resistance is arranged to cause the elastic body vibration mode to be substantially damped.

According to still another aspect of the present invention, a damping device includes a damper and a controller. The damper is connected to a movable member, and is arranged to change its damping characteristic in accordance with a variable signal that is provided to the damper. The controller, which is connected to the damper, controls the variable signal based on information of the movement of the movable member. In one embodiment, the information of the movement of the movable member includes a first mode and a second mode. In such an embodiment, the movable member may move with one of an acceleration and a deceleration in the first mode, and move at a substantially constant velocity in the second mode.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1 is a diagrammatic representation of a portion of a stage apparatus which includes magneto-rheological dampers positioned substantially between a wafer table and long mirrors in accordance with an embodiment of the present invention.

FIG. 2a is a diagrammatic top-view representation of a stage apparatus, e.g., stage apparatus 100 of FIG. 1, in accordance with an embodiment of the present invention.

FIG. 2b is a diagrammatic side-view cross-sectional representation of a stage apparatus, e.g., stage apparatus 100 of FIG. 1, in accordance with an embodiment of the present invention.

FIG. 3 is a diagrammatic representation of a magneto-rheological damper in accordance with an embodiment of the present invention.

FIG. 4 is a diagrammatic block diagram representation of the functionality of a magneto-rheological damper in accordance with an embodiment of the present invention.

FIG. 5 is a process flow diagram which illustrates the steps associated with operating a stage device which includes a magneto-rheological damper in accordance with an embodiment of the present invention.

FIG. 6 is a diagrammatic side-view representation of the deflection of a wafer table due to a double cantilever vibration mode.

FIG. 7 is a diagrammatic representation of the deflection of a wafer table due to a common table vibration mode.

FIG. 8a is a diagrammatic representation of a wafer table which includes magneto-rheological mirror dampers and a magneto-rheological table damper in a first position in accordance with an embodiment of the present invention.

FIG. 8b is a diagrammatic representation of a wafer table, e.g., wafer table 810 of FIG. 8a, which includes magneto-rheological mirror dampers and a magneto-rheological table damper in a second position in accordance with an embodiment of the present invention.

FIG. 8c is a diagrammatic representation of a wafer table, e.g., wafer table 810 of FIG. 8a, which includes magneto-rheological mirror dampers and multiple magneto-rheological table dampers in accordance with an embodiment of the present invention.

FIG. 9 is a diagrammatic representation of a photolithography apparatus in accordance with an embodiment of the present invention.

FIG. 10 is a process flow diagram which illustrates the steps associated with fabricating a semiconductor device in accordance with an embodiment of the present invention.

FIG. 11 is a process flow diagram which illustrates the steps associated with processing a wafer, i.e., step 1304 of FIG. 10, in accordance with an embodiment of the present invention.

### DETAILED DESCRIPTION OF THE EMBODIMENTS

Reducing the effect of vibrations on a precision instrument during an acceleration or deceleration portion of a wafer scan process is generally necessary in order to enable a wafer table of the precision instrument to be accurately scanned. While passive damping solutions are effective in dissipating vibrational energy, passive damping solutions may cause the wafer table to distort during an exposure portion of the scan.

In order to enable vibrations to be damped during an acceleration or deceleration portion of a wafer scan substantially without causing significant distortion or deceleration, dampers which may be controlled or adjusted in real-time may be implemented within a precision instrument. Such dampers, e.g., magneto-rheological dampers, may be activated during acceleration or deceleration in order to damp vibrations such as mirror vibrations, and deactivated during exposure to substantially prevent a wafer table from experiencing significant distortion. In other words, the use of dynamically adjustable or switchable dampers such as magneto-rheological dampers enables vibrations due to a moving stage, for example, to be damped when necessary or desired, while allowing the dampers to apply effectively no damping when damping is either not necessary or not desired.

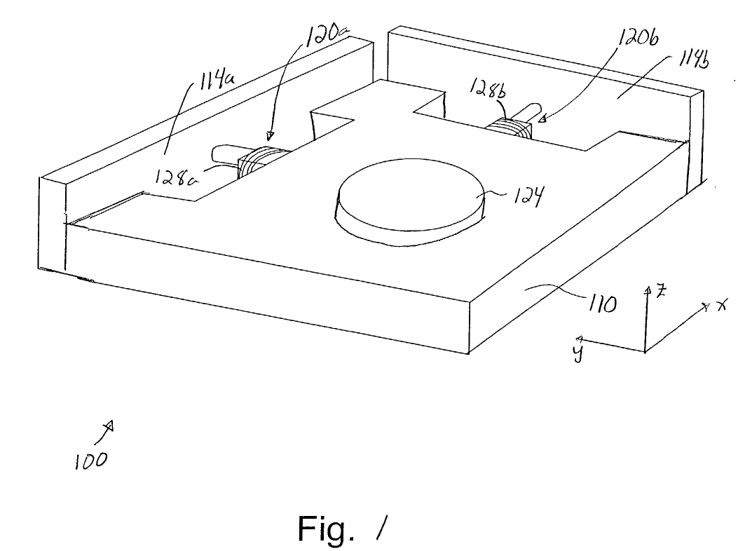

With reference to FIG. 1, a portion of an overall precision instrument such as a stage apparatus which includes dampers that may be dynamically adjusted will be described in accordance with an embodiment of the present invention. An overall stage apparatus 100 includes a wafer table 110, e.g., a fine stage, which supports a wafer chuck 124. Stage apparatus 100 may be moved in three degrees of freedom (x, y, θ_{z}) by a mover assembly, e.g., a linear motor or a planar motor that utilizes a Lorentz Force. Interferometer mirrors 114, which are part of an overall interferometer, are also included in overall stage apparatus 100. Typically, wafer table 110 is situated over a coarse stage (not shown) which imparts coarse movements while wafer table 110 imparts finer movements. When wafer table 110 is scanned, a wafer (not shown) that may be supported by wafer chuck 124 may be moved as appropriate. By way of example, a wafer may be scanned such that a particular portion of the wafer is positioned under a particular portion of a reticle.

Magneto-rheological dampers 120, or mirror deflection dampers, are positioned between wafer table 110 and interferometer mirrors 114. In general, wafer table 110 and interferometer mirrors 114 may also be coupled using substantially any suitable fastening device. Specifically, wafer table 110 and interferometer mirror 114a may be coupled through fastening devices at areas of contact, while wafer table 110 and interferometer mirror 114b may also be coupled through fastening devices at areas of contact. Suitable fastening devices include, but are not limited to, bolts and various adhesive materials.

As shown, magneto-rheological damper 120a is positioned between wafer table 110 and interferometer mirror 114a, while magneto-rheological damper 120b is positioned between wafer table 110 and interferometer mirror 114b. Interferometer mirror 114a is utilized to detect the position of wafer table 110 in a y-direction, and interferometer mirror 114b is utilized to detect the position of wafer table 110 in an x-direction. In general, one end of a magneto-rheological damper 120 may be coupled to wafer table 110 while a substantially opposite end of magneto-rheological damper 120 may be coupled to an interferometer mirror 114. Although the components of magneto-rheological dampers 120 may be widely varied, magneto-rheological dampers 120 generally include a fluid-filled cavity that contains fluid which has a relatively low viscosity when there is substantially no magnetic field, and a higher viscosity when there is a magnetic field. By applying magnetic fields around magneto-rheological dampers 120 using electromagnetic coils 128, the higher viscosity may be achieved and, hence, damping may be provided by magneto-rheological dampers 120.

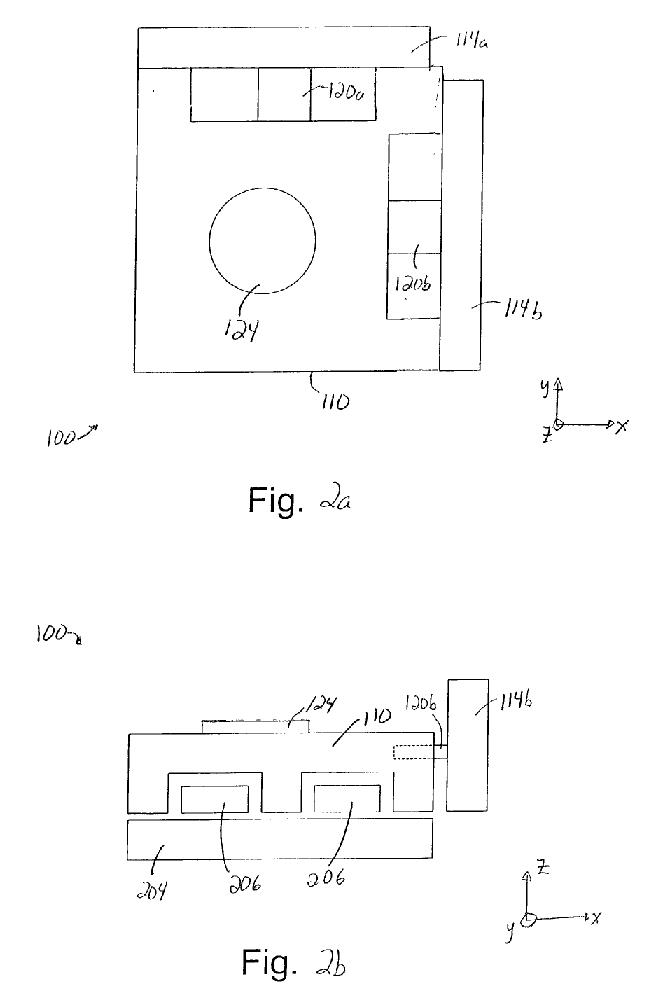

FIG. 2a is a diagrammatic top-view representation of a stage apparatus, e.g., stage apparatus 100 of FIG. 1, and FIG. 2b is a diagrammatic cross-sectional side-view representation of a stage apparatus, e.g., stage apparatus 100 of FIG. 1, in accordance with an embodiment of the present invention. As shown, magneto-rheological dampers 120 are effectively coupled to wafer table 110 and to interferometer mirrors 114. Actuators 206, e.g., voice coil motors, are positioned under wafer table 110 to enable wafer table 110 to translate linearly. Actuators may be driven for leveling motion (at least one of z, θₓ, θ_{y} directions) of wafer table 110. While wafer table 110 enables a wafer (not shown) that is positioned on wafer chuck 124 to effectively undergo fine movements, a coarse stage 204 which is positioned substantially under wafer table 110 enables the wafer to effectively undergo coarse movements.

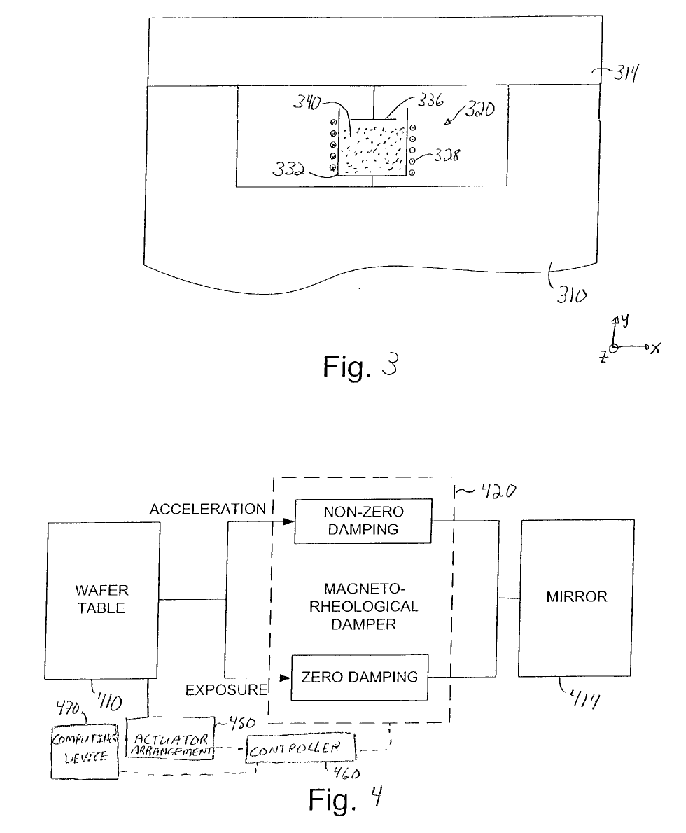

In general, magneto-rheological dampers 120 may take substantially any suitable configuration. Referring next to FIG. 3, one embodiment of a magneto-rheological damper will be described in accordance with the present invention. A magneto-rheological damper 320 may be coupled to an interferometer mirror 314 and to a wafer table 310. In the described embodiment, magneto-rheological damper 320 is a dashpot which includes a cylinder 332 and a piston 336. Cylinder 332, which may be formed from a material such as aluminum, is typically coupled to wafer table 310, while piston 336 is typically coupled to mirror 314.

Cylinder 332 is arranged to contain a magneto-rheological fluid 340, or a fluid which is relatively viscous in the presence of a magnetic field and less viscous when a magnetic field is not present. In general, a magneto-rheological fluid is a controllable fluid which may be controlled by a magnetic field. Magneto-rheological fluids are non-colloidal suspensions of polarizable or magnetically soft particles. The particles in a magneto-rheological fluid generally have a size on the order of a few microns. One example of a magneto-rheological fluid is a hydrocarbon base fluid which holds iron particles in suspension.

When magneto-rheological fluid 340 is in a non-active state, i.e., when magneto-rheological fluid 340 is not subjected to an applied magnetic field or is not magnetized, the particles in magneto-rheological fluid 340 are effectively randomly positioned. As such, when piston 336 is pushed against magneto-rheological fluid 340, piston 336 may meet relatively little resistance since magneto-rheological fluid 340 has a relatively low viscosity and, hence, magneto-rheological damper 320 provides substantially no appreciable damping. Alternatively, when magneto-rheological fluid 340 is in an active state, i.e., when magneto-rheological fluid 340 is subjected to an applied magnetic field or is in a substantially magnetized state, then the particles in magneto-rheological fluid 340 become aligned and magneto-rheological fluid 340 is characterized by a higher viscosity. Specifically, the particles in magneto-rheological fluid 340 may become aligned into structures which change the rheology of magneto-rheological fluid 340, e.g., into a substantially plastic state by altering the shear strength of magneto-rheological fluid 340. As a result, when piston 336 is pushed against magneto-rheological fluid 340, piston 336 may meet significant resistance, thereby causing magneto-rheological damper 320 to provide an appreciable amount of damping. The amount of resistance provided by magneto-rheological fluid 340 and, hence, the amount of damping provided by magneto-rheological damper 320 typically varies with the strength of the magnetic field that is effectively applied to magneto-rheological fluid 340. As the strength of the magnetic field increases, the amount of damping provided by magneto-rheological damper 320 increases.

As will be appreciated by those skilled in the art, a piston included in a dashpot typically either includes holes, or a thin gap may exist around the perimeter of the piston. When the piston is compressed, fluid flows either through the holes or around the gap with varying viscosity causing varying damping.

An electromagnetic coil 328 is positioned with respect to cylinder 332 such that when coil 328 active, as for example when current is provided to coil 328, coil 328 causes a magnetic field to be applied to magneto-rheological fluid 340. In one embodiment, by controlling the amount of current that is provided to coil 328, the strength or the magnitude of the magnetic field that is created by coil 328 may be varied. As a result, adjusting the amount of current provided to coil 328 essentially enables the amount of resistance provided by magneto-rheological fluid 340 to be adjusted in real time such that the amount of damping provided by magneto-rheological damper 320 is effectively continuously variable in real time. It should be appreciated that an off-the-shelf magneto-rheological damper, such as a magneto-rheological damper available from the Lord Corporation in Cary, N.C., may be used as an alternative to magneto-rheological damper 320.

The current that is sent to coil 328 may be controlled using substantially any suitable process. Current may be controlled by a controller which is coupled to a current amplifier and is external to the system. By way of example, a controller (not shown) which adjusts the current provided to coil 328 may receive a signal from a sensor that is arranged to sense when wafer table 310 is being scanned at a constant velocity or when wafer table is being accelerated or decelerated. The controller may then use the signal to adjust the amount of current provided to coil 328 as appropriate.

Magneto-rheological damper 320 is generally arranged to enable vibrations, e.g., elastic body vibrations, to be damped between mirror 314 and wafer table 310 when magneto-rheological fluid 340 has a relatively high viscosity. When magneto-rheological fluid 340 has a relatively low viscosity, magneto-rheological damper 320 is arranged to provide little or no damping between mirror 314 and wafer table 310. As previously mentioned, damping vibrations during an acceleration or deceleration component of a scan may prevent a subsequent exposure process from being compromised. However, applying damping during an exposure process may distort wafer table 310 and, hence, cause the exposure process to be performed inaccurately. Since magneto-rheological damper 320 is controllable, the amount of damping applied during a scan may be adjusted.

In general, magneto-rheological damper 320 is arranged to control vibrations by providing a measure of damping when necessary, and to provide substantially no damping when it is not necessary to control vibrations. FIG. 4 is a diagrammatic block diagram representation of the functionality of a magneto-rheological damper in accordance with an embodiment of the present invention. A magneto-rheological damper 420 is positioned between a wafer table 410 and a mirror 414, e.g., a long mirror or an interferometer mirror. When wafer table accelerates or decelerates, magneto-rheological damper 420 provides non-zero damping such that vibrations that are excited to uncontrollable levels may be damped. An actuator arrangement 450, which causes wafer table 410 to accelerate or decelerate, may provide a signal to a controller 460 which controls the current provided to a coil (not shown) associated with magneto-rheological damper 420. Increasing the amount of current provided to the coil increases the strength of the magnetic field generated by the coil and, hence, the amount of damping applied by magneto-rheological damper 420. Actuator arrangement 450 may include an actuator and, in one embodiment, a control mechanism which uses interferometer signals to determine how wafer table 410 is to be moved.

When wafer table 410 is moved at a constant velocity, e.g., during a wafer exposure process, magneto-rheological damper 420 may be controlled by controller 460 such that magneto-rheological damper 420 provides substantially no damping. Controller 460 may reduce the current provided to a coil (not shown) that is associated with magneto-rheological damper 420 such that a significant magnetic field is not generated by the coil. In one embodiment, controller 460 may be in communication with a computing device 470.

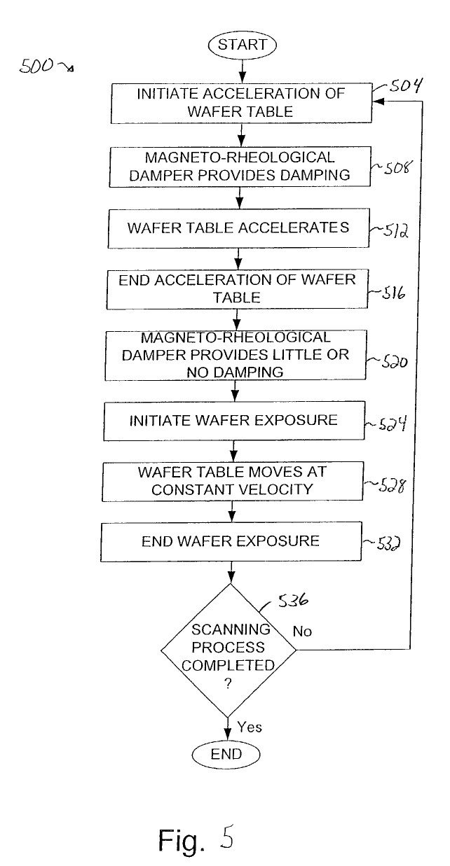

FIG. 5 is a process flow diagram which illustrates the steps associated with a scanning process performed using a stage device which includes a magneto-rheological damper in accordance with an embodiment of the present invention. A scanning process 500 begins at step 504 in which the acceleration of a wafer table is initiated. It should be appreciated that although the wafer table is described as accelerating, the acceleration of the wafer table may include the deceleration of the wafer table, as deceleration is generally a negative acceleration.

Upon initiation of the acceleration of the wafer table, a magneto-rheological damper which is coupled to the wafer table and to an interferometer mirror is activated in step 508 to provide damping. In other words, during the acceleration portion of a scan, the magneto-rheological damper is arranged to provide damping. The magneto-rheological damper may be activated by providing electric current to an electromagnetic coil associated with the magneto-rheological damper. The amount of electric current provided to the electromagnetic coil may be controlled by a control device which is in communication with a computing system. Providing damping between the wafer table and the interferometer mirror allows vibrational energy associated with the movement of the wafer table to be substantially damped. Specifically, the magneto-rheological damper, e.g., magneto-rheological damper 120a of FIG. 1, may allow elastic body vibrations on the interferometer mirror to be damped between the wafer table and the interferometer mirror, e.g., wafer table 110 and interferometer mirror 114a of FIG. 1.

Once the magneto-rheological damper provides damping, the wafer table may accelerate as necessary in step 512. Typically, the wafer table accelerates until a wafer carried by the wafer table is in a desired position. In step, 516, the acceleration of the wafer table ends. When the wafer table is no longer accelerating, and any transient effects of acceleration have been exhausted, the magneto-rheological damper no longer needs to provide damping, as vibrations generally do not significantly affect the wafer table during a constant velocity portion of a scan. Since the magneto-rheological damper no longer needs to provide damping, the magneto-rheological damper is effectively adjusted to provide substantially no appreciable damping in step 520. In one embodiment, adjusting the magneto-rheological damper to provide substantially no appreciable damping may include effectively deactivating the electromagnetic coil associated with the magneto-rheological damper, as for example by cutting the supply of current to the electromagnetic coil.

After the magneto-rheological damper is adjusted to provide substantially no appreciable damping, a wafer exposure process is initiated in step 524. Once the wafer exposure process is initiated, process flow moves to step 528 in which the wafer table moves at a constant velocity. Since the magneto-rheological damper effectively provides no damping while the wafer table moves at a constant velocity, there is substantially no distortion of the wafer table while the wafer table moves at the constant velocity.

In step 532, the wafer exposure process is completed. A determination is then made in step 536 regarding whether the scan is completed. If it is determined that the scan is not completed, then process flow returns to step 504 in which an acceleration of the wafer table is initiated. Alternatively, if it is determined in step 536 that the scan is completed, then process 500 ends.

As discussed above, magneto-rheological dampers, e.g., mirror deflection dampers, may be used to damp out vibrations which may cause mirrors to deflect or bend. Magneto-rheological dampers may also be suitable for damping vibrational modes, as for example double cantilever vibration modes or common table vibration modes, of a wafer table that are relatively common to lithography systems. A double cantilever vibration mode is often excited when a wafer table accelerates. FIG. 6 is a diagrammatic side-view representation of the deflection of a wafer table due to a double cantilever vibration mode. A wafer table 610 which is situated over a coarse stage 604 may be deflected to a deflected position 610′ as a result of a double cantilever vibration mode. Typically, the largest displacement or deflection in deflected position 610′ is near a center portion of wafer table 610.

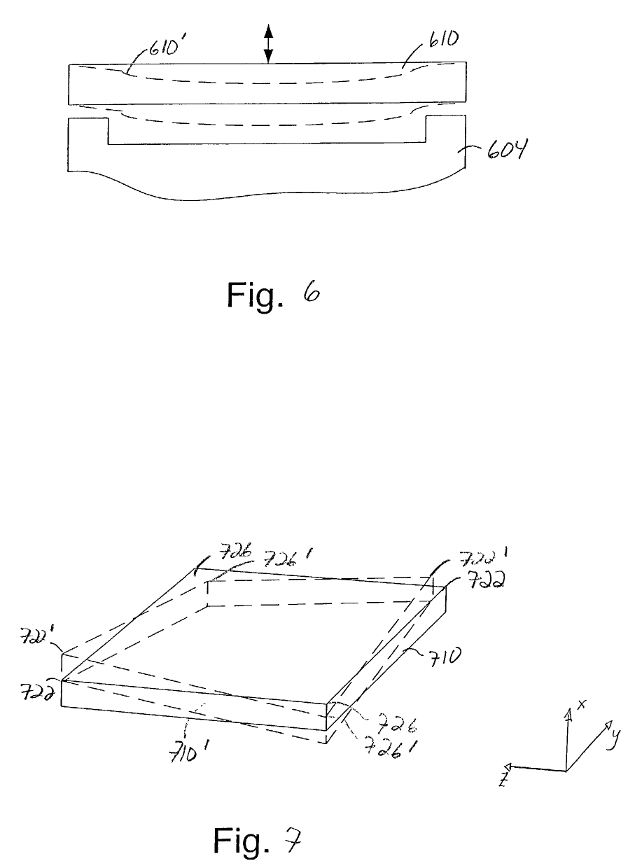

A common table vibration mode is generally an elastic body mode. FIG. 7 is a diagrammatic representation of the deflection of a wafer table due to a common table vibration mode. A wafer table 710, when subjected to a common table vibration mode, deflects to a deflected position 710′ such that opposite corners 722, 726 deflect substantially together. That is, corners 722 deflect upwards to deflected positions 722′, while corners 726 deflect downward to deflected positions 726′.

The various deflections of a wafer table that are caused by vibrations may be compensated for by placing magneto-rheological dampers on the wafer table. For example, a magneto-rheological damper which may function as a table vibration damper may be positioned on a wafer table in a spot where the relative deflection of the wafer table between the two ends of the damper is the greatest. Such magneto-rheological dampers may be used to provide damping whenever it is anticipated that the wafer table is likely to deflect. Specifically, magneto-rheological table dampers may be controlled in real-time to adjust the amount of damping provided to a wafer table in order to provide resistance to vibrations and, hence, deflections.

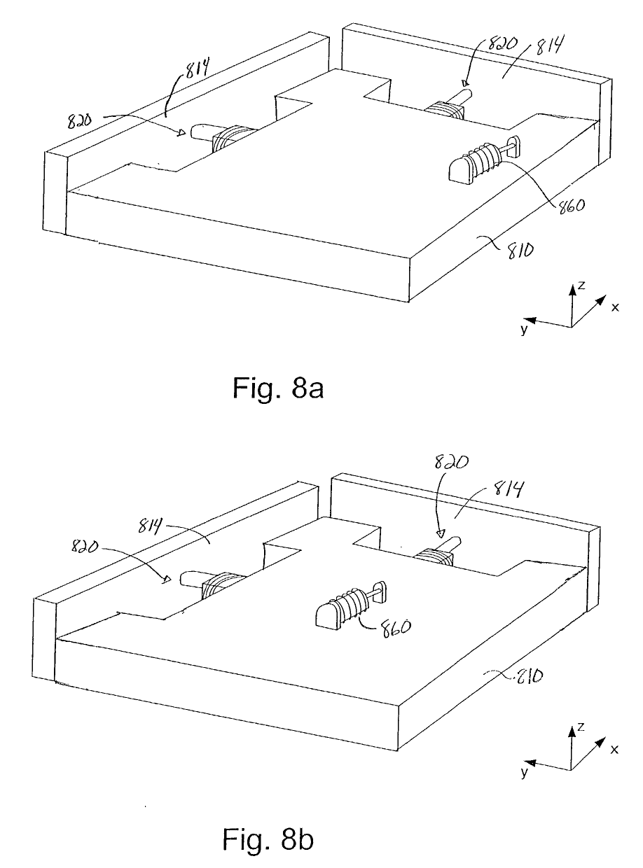

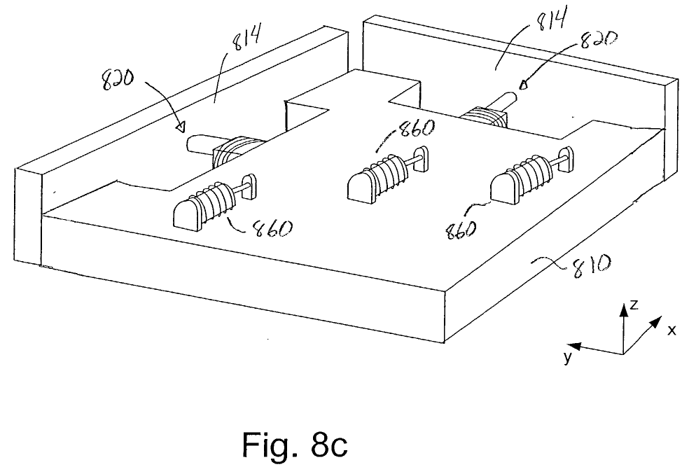

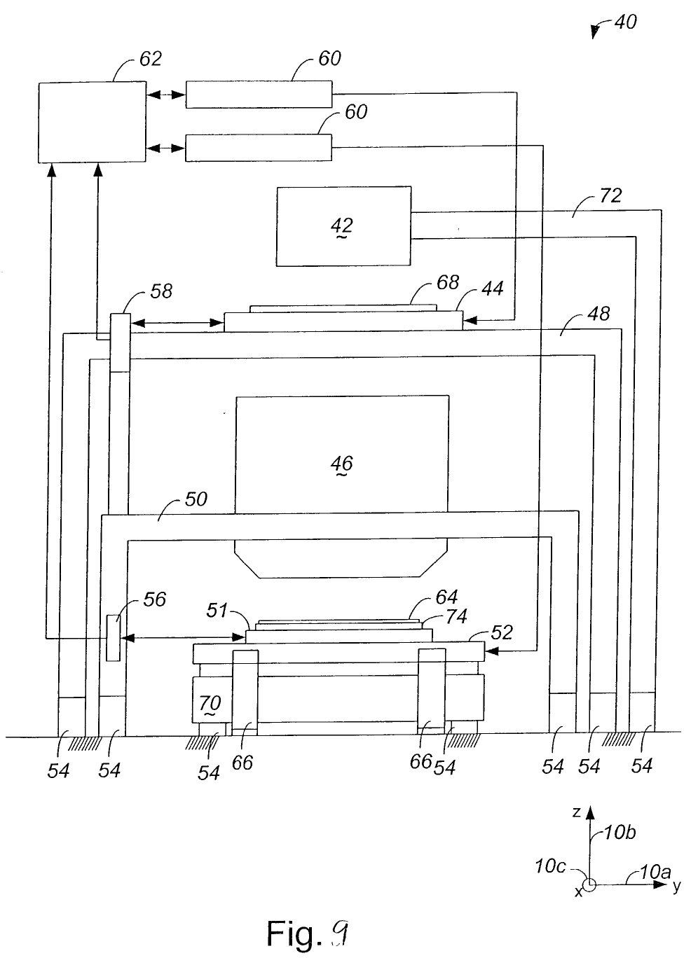

FIG. 8a is a diagrammatic representation of a wafer table which includes magneto-rheological mirror dampers and a magneto-rheological table damper in accordance with an embodiment of the present invention. A wafer table 810 may include magneto-rheological mirror dampers 820 which damp vibrations between wafer table 810 and interferometer, or long, mirrors 814. A magneto-rheological table damper 860 may be positioned on either a top surface or a bottom surface of wafer table 810, as appropriate, to damp vibration modes that are likely to be experienced by wafer table 810. In other words, the placement of table damper 860 is generally determined by the vibration modes associated with wafer table 810. By way of example, if wafer table 810 is likely to be subjected to a double cantilever vibration mode which is generally characterized by a relatively large displacement of a center of wafer table 810, then table damper 860 may be positioned substantially such that the ends of table damper 860 are placed at a location on wafer table 810 where the relative deflection between the ends is substantially greatest, as shown in FIG. 8b. Alternatively, if wafer table 810 may be subjected to both a double cantilever vibration mode or a common table vibration mode, multiple table dampers 860 may be positioned on wafer table 810, as shown in FIG. 8c.

In general, although table damper 860 of FIG. 8a may be positioned substantially anywhere on a surface of wafer table 810, table damper 860 is typically positioned such that the two ends of table damper 860 are placed at a location of wafer table 810 where the relative deflection between the two ends is most likely to be relatively large. By positioning table damper 860 near or at a location which is most likely to be subjected to deflection, table damper 860 may substantially counteract the deflection by damping out vibrations which effectively give rise to the deflection. Similarly, table dampers 860 of FIG. 8c may each be positioned in locations on wafer table 810 that may be expected to have the largest relative displacements.

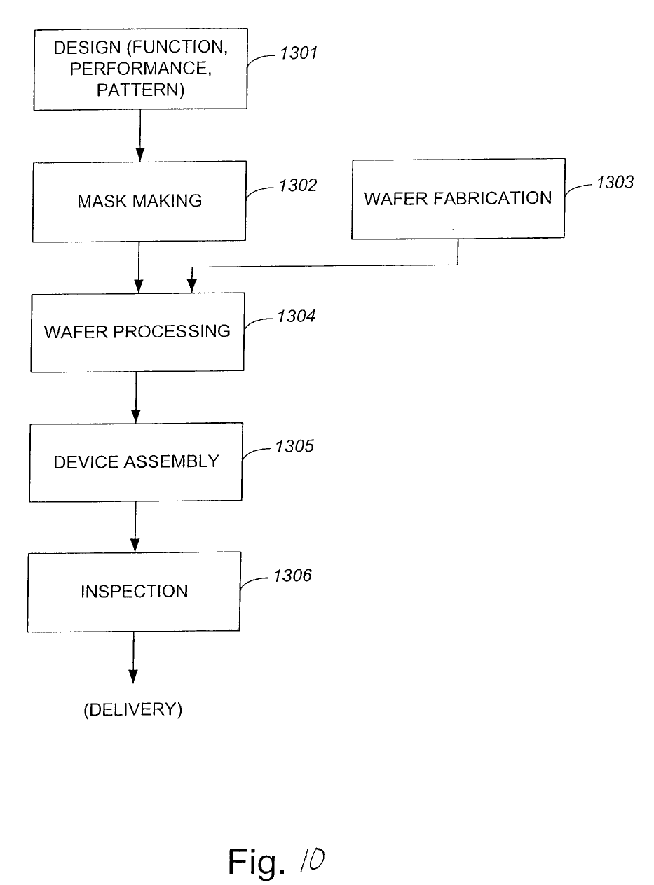

With reference to FIG. 9, a photolithography apparatus which may include magneto-rheological mirror dampers, as well as at least one magneto-rheological table damper, will be described in accordance with an embodiment of the present invention. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an El-core actuator. The planar motor which drives wafer positioning stage 52 generally uses an electromagnetic force generated by magnets and corresponding armature coils arranged in two dimensions. A wafer 64 is held in place on a wafer holder or chuck 74 which is coupled to wafer table 51. Wafer positioning stage 52 is arranged to move in multiple degrees of freedom, e.g., between three to six degrees of freedom, under the control of a control unit 60 and a system controller 62. The movement of wafer positioning stage 52 allows wafer 64 to be positioned at a desired position and orientation relative to a projection optical system 46. Heat generated during the movement of wafer positioning stage 52 may be stored by a detachable heat sink (not shown) that is coupled to wafer positioning stage 52.

Wafer table 51 may be levitated in a z-direction 10b by any number of voice coil motors (not shown), e.g., three voice coil motors. In the described embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Illumination system 42 includes an illumination source, and is arranged to project a radiant energy, e.g., light, through a mask pattern on a reticle 68 that is supported by and scanned using a reticle stage 44 which includes a coarse stage and a fine stage. The radiant energy is focused through projection optical system 46, which is supported on a projection optics frame 50 and may be supported the ground through isolators 54. Reticle stage 44 is supported on a reticle stage frame 48 and may be supported on the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper (magneto-rheological damper or table damper described in the previous embodiments of the present invention) which reduces vibrations associated with wafer table 51 such that interferometer 56 may accurately detect the position of wafer table 51. A second interferometer 58 is supported on projection optical system 46, and detects the position of reticle stage 44 which supports a reticle 68. Interferometer 58 also outputs position information to system controller 62. This invention may be embodied in reticle stage 44 in addition to the wafer table of wafer positioning stage 52. In this case, the magneto-rheological damper may be positioned between the reticle fine stage and the interferometer mirror for second interferometer 58. Also, the magneto-rheological table damper may be positioned on the fine stage of reticle stage 44.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head. Further, an adjustable force damper may also be applied to a proximity photolithography system that exposes a mask pattern by closely locating a mask and a substrate without the use of a lens assembly. Additionally, an adjustable force damper may be used in other devices including, but not limited to, other semiconductor processing equipment, machine tools, metal cutting machines, and inspection machines.

The illumination source of illumination system 42 may be g-line (436 nanometers (nm)), i-line (365 nm), a KrF excimer laser (248 nm), an ArF excimer laser (193 nm), and an F₂-type laser (157 rn). Alternatively, illumination system 42 may also use charged particle beams such as x-ray and electron beams. For instance, in the case where an electron beam is used, thermionic emission type lanthanum hexaboride (LaB₆) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultra-violet rays is preferably used. When either an F₂-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

Further, in photolithography systems, when linear motors (see U.S. Pat. Nos. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

Isolaters such as isolators 54 may generally be associated with an active vibration isolation system (AVIS). An AVIS generally controls vibrations associated with forces 112, i.e., vibrational forces, which are experienced by a stage assembly or, more generally, by a photolithography machine such as photolithography apparatus 40 which includes a stage assembly.

A photolithography system according to the above-described embodiments, e.g., a photolithography apparatus which may include one or more detachable heat sinks, may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

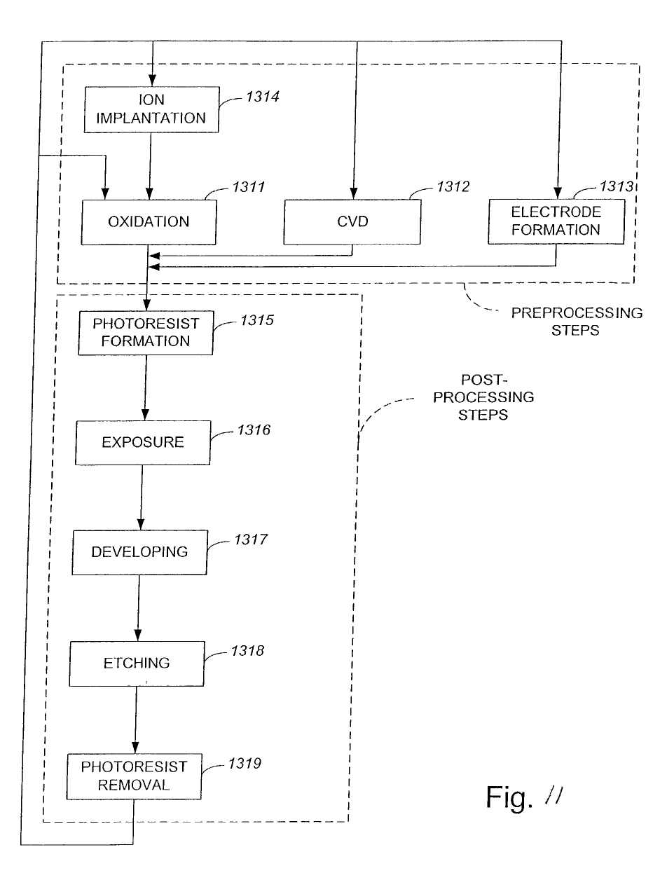

Further, semiconductor devices may be fabricated using systems described above, as will be discussed with reference to FIG. 10. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system. One process of exposing a mask pattern onto a wafer will be described below with respect to FIG. 11. In step 1305, the semiconductor device is assembled. The assembly of the semiconductor device generally includes, but is not limited to, wafer dicing processes, bonding processes, and packaging processes. Finally, the completed device is inspected in step 1306.

FIG. 11 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, magneto-rheological dampers have been described as being suitable for use in providing variable damping properties between a wafer table and an interferometer, or long, mirror of an overall stage device. It should be appreciated, however, that substantially any suitable damper which may be arranged to provide at least some damping during an acceleration portion of a scan and to provide negligible or no damping during an exposure portion of the scan may be implemented in lieu of a magneto-rheological damper. That is, substantially any sort of controllable or non-passive damper, or a damper which includes a controllable fluid, may be used. Other controllable fluids which may be used in a damper include, but are not limited to, electro-rheological fluids or ferrofluids. Ferrofluids, as will be understood to those skilled in the art, are generally suspensions of iron particles which are smaller in size than the particles which are typically included in magneto-rheological fluids.

Controllable or variable dampers other than magneto-rheological dampers may also be used to compensate for displacements of a wafer table that may occur as a result of a vibrational mode, e.g., a double cantilever vibration mode or a common table vibration mode. In one embodiment, different types of controllable dampers may be used within a single precision instrument.

While an electromagnetic coil has been described as being suitable for use in creating a magnetic field around a magneto-rheological fluid, it should be appreciated that substantially any mechanism which is capable of enabling a variable magnetic field to be created in real time may be used in lieu of an electromagnetic coil. In addition, although an electromagnetic coil has been described as being positioned around a cylinder of a damper, the electromagnetic coil may be positioned substantially anywhere without departing from the spirit or the scope of the present invention. For example, a coil may be positioned within a cylinder or within a piston.

A magneto-rheological mirror damper may be activated substantially any time a wafer table is accelerating or decelerating. As such, in the event that the acceleration or the deceleration of the wafer table does not excite vibrations, the magneto-rheological mirror damper may still be activated, i.e., arranged to provide damping. In one embodiment, however, a magneto-rheological mirror damper may be arranged to be activated when a wafer table is accelerating or decelerating substantially only when vibrations are sensed. That is, a magneto-rheological mirror damper may be controlled such that the magneto-rheological mirror damper is substantially not activated unless an accelerating or decelerating wafer table causes vibrations to be excited.

In general, the steps associated with the methods of the present invention may vary widely. Steps may be added, removed, altered, and reordered. By way of example, a magneto-rheological damper may be arranged to provide damping before an acceleration of a wafer table is initiated. Therefore, the present examples are to be considered as illustrative and not restrictive, and the invention is not to be limited to the details given herein, but may be modified within the scope of the appended claims.

What is claimed is:

1. A method for adjusting an amount of resistance on a stage device, the stage device including a table and at least a first surface, the stage device also including a coupler positioned substantially between the table and the first surface, the method comprising:
accelerating the table;
applying a resistance between the table and the first surface when the table is accelerating, wherein applying the resistance includes providing a first adjustment to the coupler; and
substantially removing the resistance from between the table and the first surface when the table is not accelerating, wherein the resistance is substantially removed by providing a second adjustment to the coupler.

2. The method of claim 1 wherein the first surface is a surface of a mirror associated with the stage device.

3. The method of claim 2 wherein the coupler is a controllable damper arrangement, and applying the resistance between the table and the first surface includes increasing a signal provided to the controllable damper arrangement.

4. The method of claim 3 wherein substantially removing the resistance from between the table and the first surface includes decreasing the signal provided to the controllable damper arrangement.

5. The method of claim 4 wherein the controllable damper arrangement includes a magneto-rheological fluid, a piston, and an electromagnetic coil.

6. The method of claim 5 wherein increasing the signal provided to the controllable damper arrangement includes increasing an amount of current to the electro-magnetic coil to substantially increase a viscosity of the magneto-rheological fluid by substantially increasing a strength of an applied magnetic field associated with the controllable damper arrangement.

7. The method of claim 5 wherein decreasing the signal provided to the controllable damper arrangement includes decreasing an amount of current to the electro-magnetic coil to substantially decrease a viscosity of the magneto-rheological fluid by substantially decreasing a strength of an applied magnetic field associated with the controllable damper arrangement.

8. The method of claim 1 wherein applying the resistance between the table and the first surface when the table is accelerating includes applying the resistance to compensate for vibrations excited when the table is accelerating.

9. The method of claim 1 wherein the first surface is associated with an interferometer.

10. The method of claim 1 further including:
moving the table at a substantially constant velocity when the resistance is substantially removed.

11. The method of claim 1 wherein the stage device further includes a first damper, the first damper being arranged to substantially damp an elastic body vibration of the table, the method further including:
applying a damping to the table to substantially counteract the elastic body vibration of the table, wherein applying the damping includes substantially adjusting the first damper.

12. The method of claim 11 wherein the first damper is a first magneto-rheological damper, and adjusting the first damper includes increasing a magnetic field associated with the first magneto-rheological damper to increase the damping and decreasing the magnetic field associated with the first magneto-rheological damper to decrease the damping.

13. A method for operating an exposure apparatus comprising the method for adjusting an amount of resistance of claim 1.

14. A method for making an object including at least a photolithography process, wherein the photolithography process utilizes the method of operating an exposure apparatus of claim 13.

15. A method for making a wafer utilizing the method of operating an exposure apparatus of claim 13.

16. A method for performing a scan using a stage device, the stage device including a table and a damping device, the damping device being positioned on the table, the method comprising:
initiating a scan using the table, wherein initiating the scan using the table is arranged to excite at least one elastic body vibration mode associated with the table, the at least one elastic body vibration mode being arranged to cause a deflection of at least a section of the table; and
adjusting a parameter associated with the damping device to substantially counteract the at least one elastic body vibration mode to substantially reduce the deflection.

17. The method of claim 16 wherein the damping device is a magneto-rheological damper arrangement and the method further includes:
determining when the at least one elastic body vibration mode is not excited; and
adjusting the magneto-rheological damper arrangement to provide substantially no damping when it is determined that the at least one elastic body vibration mode is not excited.

18. The method of claim 17 wherein the magneto-rheological damper arrangement includes an electromagnetic coil, and adjusting the parameter associated with the magneto-rheological damper arrangement includes adjusting a level of current provided to the electromagnetic coil to substantially alter an applied magnetic field associated with the magneto-rheological damper arrangement.

19. A method for operating an exposure apparatus comprising the method for performing a scan of claim 16.

20. A method for making an object including at least a photolithography process, wherein the photolithography process utilizes the method of operating an exposure apparatus of claim 19.

21. A method for making a wafer utilizing the method of operating an exposure apparatus of claim 19.

22. A stage apparatus comprising:
a first stage;
a mirror;
at least one actuator, the at least one actuator being arranged to enable the first stage to scan, wherein the at least one actuator is arranged to excite at least one vibrational mode associated with the stage apparatus; and
a first arrangement, the first arrangement being arranged between the first stage and the mirror, the first arrangement being arranged to receive a variable signal, the variable signal being arranged to control an amount of resistance associated with the first arrangement, wherein a first amount of resistance is arranged to cause the at least one vibrational mode to be substantially damped.

23. The stage apparatus of claim 22 wherein the first arrangement includes a controllable fluid, and wherein the variable signal is arranged to control a viscosity associated with the controllable fluid, the viscosity being associated with the resistance.

24. The stage apparatus of claim 22 wherein the first arrangement includes a magneto-rheological damper and an electromagnetic coil, wherein the variable signal is a current provided to the electromagnetic coil and is variable substantially in real-time.

25. The stage apparatus of claim 22 wherein the at least one vibrational mode is associated with an acceleration of the first stage when the first stage scans and the first amount of resistance is applied substantially between the first stage and the mirror, the first arrangement having the first amount of resistance during the acceleration.

26. The stage apparatus of claim 25 wherein when the first stage scans at a substantially constant velocity, the first arrangement is arranged to provide substantially no resistance between the first stage and the mirror.

27. The stage apparatus of claim 22 wherein the first stage is arranged to have an associated elastic body vibration mode, and the stage apparatus further includes:
a second arrangement, the second arrangement being arranged substantially on the first stage, wherein the second arrangement is arranged to receive a controllable signal, the controllable signal being arranged to control an amount of resistance associated with the second arrangement, wherein a second amount of resistance is arranged to cause the elastic body vibration mode to be substantially damped.

28. The stage apparatus of claim 27 wherein the second arrangement is a magneto-rheological damper, and wherein the controllable signal is arranged to be varied in real-time to control an amount of damping associated with the magneto-rheological damper.

29. An exposure apparatus comprising the stage apparatus of claim 22.

30. A device manufactured with the exposure apparatus of claim 29.

31. A wafer on which an image has been formed by the exposure apparatus of claim 29.

32. A stage apparatus comprising:
a first stage;
at least one actuator, the at least one actuator being arranged to enable of the first stage to scan, wherein the at least one actuator is arranged to excite at least one vibrational mode associated with the first stage; and
a first arrangement, the first arrangement being arranged substantially on a surface of the first stage, the first arrangement being arranged to receive a variable signal, the variable signal being arranged to control an amount of resistance associated with the first arrangement, wherein a first amount of resistance is arranged to cause the at least one vibrational mode associated with the first stage to be substantially damped.

33. The stage apparatus of claim 32 wherein the first arrangement includes a controllable fluid, and wherein the variable signal is arranged to control a viscosity associated with the controllable fluid, the viscosity being associated with the resistance.

34. The stage apparatus of claim 32 wherein the first arrangement includes a magneto-rheological damper and an electromagnetic coil, wherein the variable signal is a current provided to the electromagnetic coil.

35. The stage apparatus of claim 32 wherein the first arrangement is a magneto-rheological damper, and wherein the controllable signal is arranged to be varied in real-time to control an amount of damping associated with the magneto-rheological damper.

35. An exposure apparatus comprising the stage apparatus of claim 32.

36. A device manufactured with the exposure apparatus of claim 35.

37. A wafer on which an image has been formed by the exposure apparatus of claim 35.

38. A damping device comprising:
a damper connected to a movable member, the damper being arranged to change its damping characteristic in accordance with a variable signal that is provided to the damper; and
a controller connected to the damper, the controller controlling the variable signal based on information of the movement of the movable member.

39. The damping device of claim 38 wherein the information of the movement of the movable member includes a first mode and a second mode, whereby the movable member moves with one of an acceleration and a deceleration in the first mode, and the movable member moves at a substantially constant velocity in the second mode.

40. The damping device of claim 38 wherein the damper changes an amount of damping.

41. An exposure apparatus comprising the damping device of claim 39 wherein an exposure motion is performed during the second mode.

42. A device manufactured with the exposure apparatus of claim 42.

43. A wafer in which an image has been formed by the exposure apparatus of claim 42.

44. A stage apparatus comprising the damping device of claim 38.

45. A method for adjusting an amount of resistance on a stage device, the stage device including a table and at least a first surface, the stage device also including a coupler positioned substantially between the table and the first surface, the method comprising:
accelerating the table;
applying a resistance between the table and the first surface when the table is expected to vibrate, wherein applying the resistance includes providing a first adjustment to the coupler; and
substantially removing the resistance from between the table and the first surface when the table is substantially not expected to vibrate, wherein the resistance is substantially removed by providing a second adjustment to the coupler.

46. The method of claim 45 wherein when the table is expected to vibrate, the table is expected to vibrate due to an acceleration of the table.

47. A method for operating an exposure apparatus comprising the method for adjusting an amount of resistance of claim 45.

48. A method for making an object including at least a photolithography process, wherein the photolithography process utilizes the method of operating an exposure apparatus of claim 45.

49. A method for making a wafer utilizing the method of operating an exposure apparatus of claim 45.
